(19) United States
(12) Patent Application Publication
(10) Pub. No.: US 2020/0026707 A1
(43) Pub. Date: Jan. 23, 2020

(54) METHOD AND SYSTEM FOR MACHINE LEARNING OF OPTIMIZED USER OUTREACH BASED ON SPARSE DATA

(71) Applicant: KONINKLIJKE PHILIPS N.V., Eindhoven (NL)

(72) Inventors: Aart Tijmen VAN HALTEREN, Geldrop (NL); Seyed Amin TABATABAEI, Eindhoven (NL); Mark HOOGENDOORN, Eindhoven (NL)

(21) Appl. No.: 16/459,708

(22) Filed: Jul. 2, 2019

Related U.S. Application Data
(60) Provisional application No. 62/700,547, filed on Jul. 19, 2018.

(51) Int. Cl. G06F 16/2457; G06F 16/29; G06F 16/2455; G06N 20/00

(52) U.S. Cl. CPC G06F 16/24575; G06N 20/00; G06F 16/24568; G06F 16/29

(57) ABSTRACT

A method of optimizing user outreach for a subject, including: determining the N closest other users to the subject; learning an outreach policy for the subject using reinforcement learning based upon outreach data of the N closest other users and the subject; determining an outreach action for the subject based upon the learned outreach policy; performing the outreach action; collecting new outreach data; and determining a new value of N.

### CROSS-REFERENCE TO PRIOR APPLICATIONS

This application claims the benefit of U.S. Patent Application No. 62/700,547, filed on 19 Jul. 2018. This application is hereby incorporated by reference herein

### TECHNICAL FIELD

Various exemplary embodiments disclosed herein relate generally to a method and system for machine learning of optimized user outreach based on sparse data.

### BACKGROUND

Computer initiated messages may be used to reach out to users to encourage certain activities, to offer certain interventions, to request information, etc. Adaptation of the timing and the content of these computer-initiated messages to the user may make the impact of these messages much more effective compared to a one-size-fits-all strategy.

### SUMMARY

A summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various embodiments relate to a method of optimizing user outreach for a subject, including: determining the N closest other users to the subject; learning an outreach policy for the subject using reinforcement learning based upon outreach data of the N closest other users and the subject; determining an outreach action for the subject based upon the learned outreach policy;

performing the outreach action; collecting new outreach data; and determining a new value of N.

Various embodiments are described, further including repeating with the new value of N the steps of: determining the N closest other users to the subject; learning an outreach policy for the subject using reinforcement learning based upon outreach data of the N closest other users and the subject; determining an outreach action for the subject based upon the learned outreach policy;

performing the outreach action; collecting new outreach data; and determining a new value of N.

Various embodiments are described, wherein the new value of N becomes zero.

Various embodiments are described, wherein the reinforcement learning includes one of Q-learning and least square policy iteration.

Various embodiments are described, wherein the outreach action includes sending a message to the subject.

Various embodiments are described, wherein the learned outreach policy determines the time to send the message and the content of the message.

Various embodiments are described, wherein determining a new value of N is based upon the new outreach data.

Various embodiments are described, wherein determining a new value of N is based upon a predetermined function that decreases the value of N.

Various embodiments are described, wherein determining the N closest other users to the subject includes calculating a distance between the subject and other users based a predetermined set of parameters in the outreach data.

Further various embodiments relate to a non-transitory machine-readable storage medium encoded with instructions for optimizing user outreach for a subject, including: instructions for determining the N closest other users to the subject; instructions for learning an outreach policy for the subject using reinforcement learning based upon outreach data of the N closest other users and the subject; instructions for determining an outreach action for the subject based upon the learned outreach policy; instructions for performing the outreach action; instructions for collecting new outreach data; and instructions for determining a new value of N.

Various embodiments are described, further including repeating with the new value of N the instructions for: determining the N closest other users to the subject; learning an outreach policy for the subject using reinforcement learning based upon outreach data of the N closest other users and the subject; determining an outreach action for the subject based upon the learned outreach policy; performing the outreach action; collecting new outreach data; and determining a new value of N.

Various embodiments are described, wherein the new value of N becomes zero.

Various embodiments are described, wherein the reinforcement learning includes one of Q-learning and least square policy iteration.

Various embodiments are described, wherein the outreach action includes sending a message to the subject.

Various embodiments are described, wherein the learned outreach policy determines the time to send the message and the content of the message.

Various embodiments are described, wherein instructions for determining a new value of N is based upon the new outreach data.

Various embodiments are described, wherein instructions for determining a new value of N is based upon a predetermined function that decreases the value of N.

Various embodiments are described, wherein instructions for determining the N closest other users to the subject includes calculating a distance between the subject and other users based a predetermined set of parameters in the outreach data.

### BRIEF DESCRIPTION OF THE DRAWINGS

In order to better understand various exemplary embodiments, reference is made to the accompanying drawings, wherein:

FIG. 1 illustrates a cluster plot of users for two parameters X1 and X2;

FIG. 2 is a plot of performance versus learning time for the various approaches;

FIG. 3 is the same cluster plot as shown in FIG. 1 with a few specific users highlighted;

FIG. 4 is a plot of the users as shown in FIG. 1, but the users have not been clustered;

FIG. 5 is a plot of performance versus learning time for the various approaches including the centralizing approach and the narrowing-centralizing approach; and

FIG. 6 is a plot of the accumulated reward versus time for each of the approaches based upon the results of the simulation.

To facilitate understanding, identical reference numerals have been used to designate elements having substantially the same or similar structure and/or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Computer initiated messages may be used to reach out to users to encourage certain activities or to request information. Adaptation of the timing and the content of these computer-initiated messages to the user may make the impact of these messages much more effective as compared to a one-size-fits-all approach, however, this adaptation for each user is very slow. Embodiments of a computer implemented method that is fast at learning the timing and content of messages to meet the personal outreach preferences of an individual are described herein.

Many strategies are possible for designing a policy (“when” to send “what” message) for a system-initiated outreach to a user. System initiated outreach happens in many situations, such as a customer contact center that reaches out to customers, mobile applications that send out a notification to a mobile phone user, and chat bots that initiate a conversation. The simplest policy is to schedule the system-initiated outreach at a fixed time (e.g., every morning at 7 am) which is usually based on the knowledge of system designer about a user's preferences and about the best policy (“when” is the best time to send “what”, to have the best effect in average for all users).

Smart phones and wearable devices not only may be used to send messages directly to the users, but also to collect data. This data may be used to adapt the services/applications for individual users.

Reinforcement learning is a promising approach to perform such personalization using collected data from users. However, because the data is gathered gradually, the performance initially is not good, and it takes a long time to reach an acceptable performance.

The embodiments described herein are based on using individual data and population data to narrow the outreach strategy down to an optimized personal strategy. It may be used to speed up the improvement of the performance of reinforcement algorithms.

In many real-world situations there is initially not enough data from individuals to use a classic machine learning approach and as a result the process to learn a good strategy for an individual is very slow. Reinforcement learning is a common approach to learn a good policy while gathering data at the same time. However, the more tailored an approach needs to be towards an individual, the slower the learning speed. There are different strategies which may be used to strike a balance between the performance of reinforcement learning and its learning speed. These strategies use reinforcement learning methods, and can basically be categorized as: separated; pooled/one-size-fits-all; and cluster-based learning.

The goal of the separated approach is to adapt the policy to each individual to make services more effective (i.e., personalization). Therefore, a separate policy is learned and used for each user, and to learn the policy at any time step, just the data gathered for this individual user is used. The advantage of this approach is that at the end of the learning process, the policy is fully personalized for this user, and as a result, its performance is very high.

In the pooled/one-size-fits-all approach, the data of all users is used to learn one policy for all the users. The goal of this approach is to learn the policy as fast as possible. To do that, at each time step all gathered data from all users are used for learning the policy. The advantage of this approach is that the learning may be done very fast while the clear disadvantage is that the approach is not tailored towards any specific users.

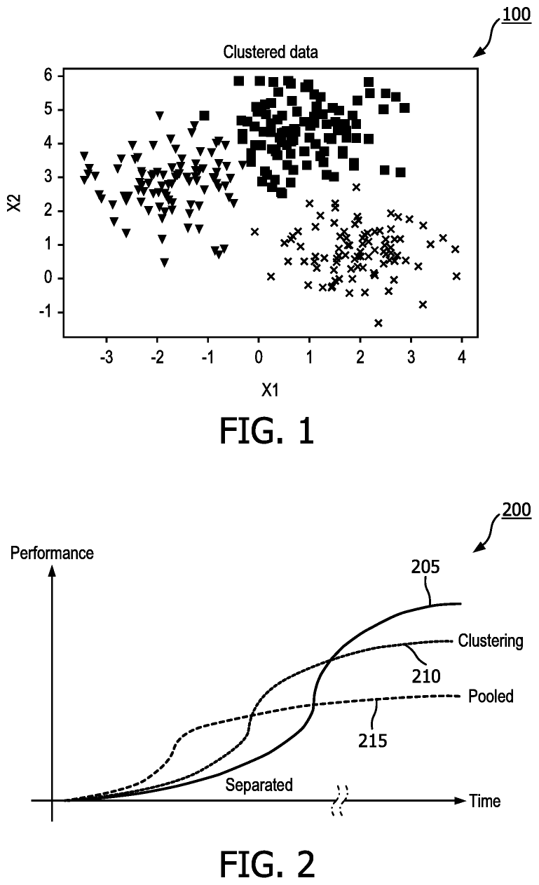

The cluster-based learning approach is positioned between the separated and pooled/one-size-fits-all approaches. The aim is to make the reinforcement learning process more effective while still enabling a level of personalization. In this approach, users who show similar behavior are clustered and one policy is learned for each cluster. FIG. 1 illustrates a cluster plot of users for two parameters X1 and X2. The cluster plot 100 plots users based upon two paraments X1 and X2 and shows users clustered into three clusters. The three clusters are indicated using the three symbols: ▾; ▪; and X. In this case, three policies are developed: one for each cluster. This approach improves the learning speed in comparison to the separated approach.

FIG. 2 is a plot of performance versus learning time for the various approaches. The vertical axis of the plot 200 shows performance and the horizontal axis show learning time. The separated approach plot 205 shows that a problem of this approach is a very low speed of learning. The reason for this problem is that each user provides limited experiences (i.e., data) per each moment in time. As a result, even though the final performance of the policy using the separated approach for each individual is very high, the separated approach takes a long time to reach this performance.

The pooled/one-size-fits-all approach 215 is the opposite of the separated approach 205. This approach uses the data gathered from all users to learn one policy for all of the users. The pooled/one-size-fits-all approach plot 215 shows that learning happens quickly, and the learned policy is similar across all users. As the pooled/one-size-fits-all approach plot 215 shows, eventually the performance of the pooled/one-size-fits-all approach learned policy is low on average.

The cluster-based learning approach is an intermediate approach as shown by the plot 210. In this approach, one policy is learned for each cluster. As a result, the speed of learning phase is better than separated approach 295, but worse than pooled/one-size-fits-all approach 215. On the other hand, the performance of the final cluster-based learning policy 210 is better than pooled/one-size-fits-all approach 215, but worse than separated approach 205.

As it can be seen in FIG. 2, the pooled/one-size-fits-all approach 215 is the fastest learning rate at the initial phase of learning process, while the performance of the final policy learned by this approach is the worst. On the other hand, although the learning rate of the separated approach 205 is not fast, the performance of the final policy learned by this approach is very good for each individual user. As an intermediate approach, the clustering approach 210 has an intermediate learning speed and also the performance of the final policy is between the other two approaches.

An embodiment of a computer implemented method will now be described that learns the timing and content of messages to meet the personal outreach preferences of an individual user. A feature of this embodiment is to vary the number of users from which data is used to establish personalization. This embodiment strives to get rid of the disadvantages of both the pooled and separate approaches while being more flexible compared to the clustering-based approach. This embodiment results in the best level of personalization given the amount of data that is available.

This embodiment uses a narrowing centralizing approach. The narrowing centralizing approach uses data of the closest users around a specific user to generate the policy for that specific user. The approach includes two parts: centralizing that determines what users are relevant to consider (i.e., the neighborhood), given a specific number of other users to consider; and narrowing, where this specific number of users is further narrowed to a relevant subset according to some automatic reduction regime.

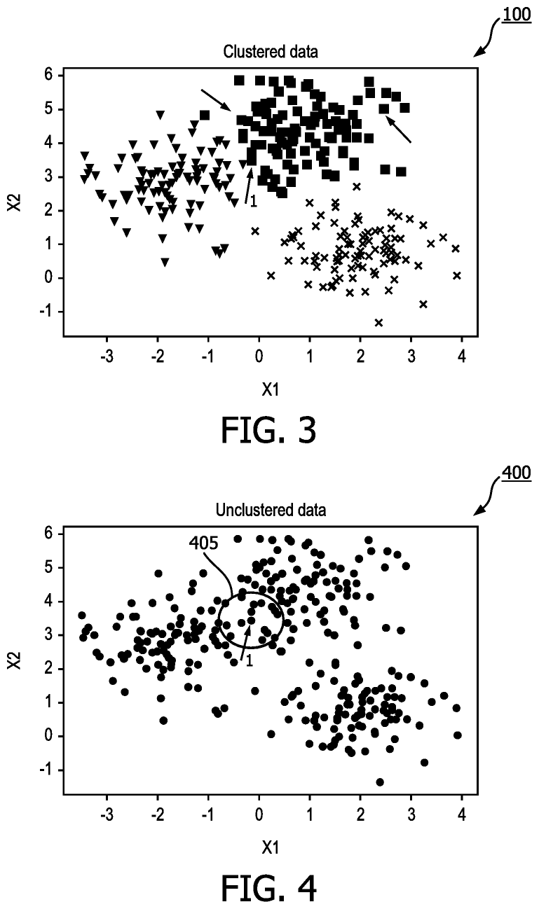

As mentioned, in the clustering approach, one policy is learned and used for each cluster of users. FIG. 3 illustrates one drawback of the clustered approach. FIG. 3 is the same cluster plot as shown in FIG. 1 with a few specific users highlighted. The drawback to the clustered approach is that, even though the learned policy would be very good for the users in the center of the cluster, it is less effective for the users close to the borders. For example, in FIG. 3, one policy is learned for all users in the ▪ cluster. However, user number 1 is in the same cluster with others (highlighted by arrows) who are very distant from one another in terms of their characteristics.

The idea of centralizing is to learn based on the data gathered from a specific user and the N most similar users to the specific user (i.e., the N nearest neighbors). FIG. 4 is a plot 400 of the users as shown in FIG. 1, but the users have not been clustered. In FIG. 4 a specific user 1 is annotated. The circle 405 shows the nearest neighbors for the specific user 1. To find nearest neighbors of a specific user 1, a measure of similarity is calculated for all of the users in the plot 400. Any type of distance metric may be used, but, for example, distances may be estimated based on the prior knowledge about the users combined with the experiences obtained from the specific user 1 when messages are sent. The value of N may be fixed, but it is also possible to change its value over time, which is the next part of approach described below.

As described, the proposed centralized approach has a hyperparameter; N, which may have two extreme values: N=0: this case is the same as the separated approach; and N=number of all users: this case is the same as pooled/one-size-fits-all approach. A feature of the narrowing-centralizing approach is that the value of N may be dynamic during the learning time. To take the advantage of pooled/one-size-fits-all approach, N should initially have a large value (e.g., N=number of users), and to take the advantageous of separated approach, N should have a small value (e.g., N=0) at the end. Therefore, it would be possible to initially have a large value for N, and decrease it over time.

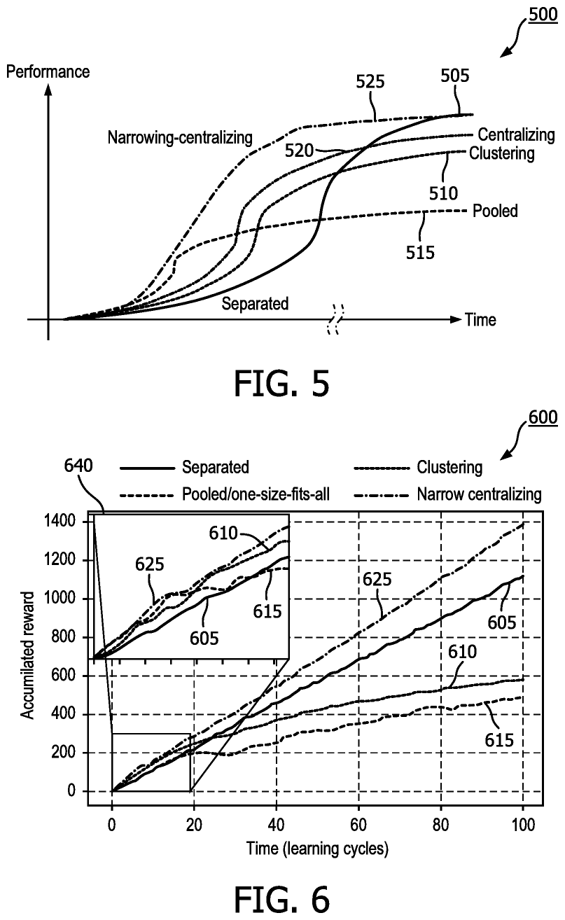

Given such a decreasing N, the beginning approach is like the pooled/one-size-fits-all approach, and the speed of the learning approach is high. On the other hand, at the end the learning period it becomes the same as separated approach, and the performance of the final learned policy will be high. By gradually decreasing the value of N, the shift from the pooled/one-size-fits-all approach to the separated approach would be done smoothly by selecting the best number of neighbors at each time point, while being more flexible compared to using fixed clusters. FIG. 5 is a plot of performance versus learning time for the various approaches including the centralizing approach and the narrowing-centralizing approach. The vertical axis of the plot 500 shows performance and the horizontal axis show learning time. As is depicted in FIG. 5, the centralizing approach 520 learns more quickly than the clustering approach 510 and the separated approach 505, but it still learns more slowly than the pooled approach 515. Further, the centralizing approach 520 has better performance than the clustering approach 510 and the pooled approach 515, but does not perform as well as the separated approach 505.

The narrowing-centralizing approach 525 on the other hand learns more quickly than the other four approaches, while achieving the same performance as the separate approach 505, which is better than the centralized approach 520, the clustering approach 510, and the pooled approach 505. Hence, the narrowing-centralizing approach 525 has the best performance and learning time among all of the approaches.

The following pseudo code shows an implementation of the narrowing-centralizing approach.

```
N = number-of-users
For t = 1 to end-time
  For current_user = 1 to number-of-users
    similar_users = get_closest_users( current user_id = current_user, size_of_group = N)
    Data = get_data (list_of_users = similar_users)
    learned_policy = learn_policy ( learning_data = Data
    selected_action = get_action (policy = learned_policy , status= current_status)
    do_action ( user = current_user, action = selected_action)
  observe_and_collect_new_data( )
  N = determine_new_value(N)
```

The pseudo code begins by initializing N to the total number of users who will be evaluated. It is noted that some other value less than the total number of users may also be used. Next the pseudo code has a time loop and a user loop. The time loop loops over all of the valid times until the end time. The user loop loops over all users from 1 to the number-of-users.

Next, the following steps are carried out for each user. First a set of similar_users is obtained by determining the N closest users to the current user. Next, the relevant user data for the N closest users and the current user are obtained to be used as the learning_data. Then, the learning_data is used to train a policy learned_policy for the user. This learned_policy may be learned using any reinforcement learning algorithm, such as for example, Q-learning or least square policy iteration. The learned_policy is then used to determine the action for the user based upon the learned policy. Finally, the selected action is carried out with respect to the current user. These steps are then repeated until the last user.

Next, new data is observed and collected as time passes. Also, a new value of N is determined. This may be done in any manner that converges on a learned_policy that accurately reflects each specific user's preferences. This value of N may generally be reduced as time passes. The new value of N may be reduced in some fixed manner, such based on a linear function or in some non-linear function. For example, N may be reduced by 5% for each iteration in time. Further, N may be varied depending upon a performance metric based upon the performance of the learned_policy for the users. For example, when the learned_policy accurately predicts the time and content of a message that the user responds to positively, then the value of N may be reduced more quickly, versus when the user does not respond positively to the message. In such a case N may be more slowly reduced or even increased at a given time. Other various methods for determining a new value for N may be used as well.

A simulation-based example was developed to determine if the narrowing-centralizing approach achieves better performance and learning times than separated approach, the clustering approach, and the pooled approach. In this experiment, an open source simulator was used that was proposed in el Hassouni, A., Hoogendoorn, M., van Otterlo, M., Barbaro, E.: Personalization of health interventions using cluster-based reinforcement learning, arXiv preprint arXiv:1804.03592 (2018). This open source simulator simulates the schedule of people with different lifestyles and different habits, and how they spend their time on different activities. In the simulator, people can be spawned from different profiles (e.g., working person, retired person). In the simulator, messages may be sent to the simulated users suggesting a workout, which they can either accept or not. Simulated users may respond differently to such messages, depending on their preferred time to receive a message and their schedule. The goal is to send messages at the right time such that the simulated users accept the suggestion in the message, work out more, and live a healthier life. The profiles are however unknown to the learner that decides on when to send a message to a simulated user. It is therefore required to learn the best policy for sending messages.

FIG. 6 is a plot of the accumulated reward versus time for each of the approaches based upon the results of the simulation. The plot 600 also shows an expanded section 640 that shows the first 20 seconds of the plot in greater detail. As can be seen, the pooled/one-size-fits-all approach 615 works well at the beginning, but its performance as time proceeds is not good. On the other hand, the performance of separated approach 605 is not good during the first time periods but is good at the end. The performance of clustering approach 610 is good at the beginning, but at the very end, it is not as good as the separated approach. The narrowing-centralization approach 625 starts as good as pooled and clustering approach 615, and at the end, it performs better than all of the other strategies by accumulating more rewards than any other approach.

Now various embodiments of applications of the narrowing-centralizing approach will be described.

One embodiment of the narrowing-centralizing approach is used to optimize the effectiveness of a medication reminder service. This service aims to remind patients to take their medication by sending them a reminder message on their mobile phone (or on a display of their medication dispenser or any other device that the patient interacts with). The reminder service has a database with many kinds of reminder messages, varying from directive messages, such as “It is time to take your medication” to more persuasive messages, such as “People who take their medication on time have fewer complications” or “Make your doctor proud and follow his advice to take your meds”. It is known that some people respond better to specific messages than others.

To learn the best policy for communicating with one patient, this embodiment would find the most similar patients according to their socio-demographic properties (e.g., ZIP code, age group, disease severity) and also their responses to the previously sent messages (e.g., accepting or rejecting an action suggested in a message, responding that I have already taken my medication, muting the application for next 12 hours, etc.) to learn what type of message and what time is the most effective for an individual patient. Over time, by collecting more and more data about the patient's responses to different messages, the embodiment becomes less dependent on similar patients and will be more personalized for this specific patient.

Another embodiment of the narrowing-centralizing approach is used to optimize the response rate to a daily survey of a hypertension management service (HMS). The HMS may be an e-Health application that coaches participants on food intake and physical activity. Part of the service is a daily short survey about food intake and exercise. The response rate to this daily survey varies depending on at what moment during the day the survey is pushed to the participants.

When a new patient joins the HMS service, this embodiment would find similar participants of the HMS according to health parameters (e.g., blood pressure, use of medication, BMI, etc.) and according to their psycho-social parameters (e.g., motivation, self-efficacy, activation level, etc.). Using the timing policy of these similar patients, the new patient would initially receive the daily survey. However, based upon the response rate of the new patient, the HMS service would quickly learn a more personalized timing. By narrowing the number of neighbors (similar according to health parameters, psycho-social parameter and response times), the HMS service would quickly converge to an optimal timing personalized for each participant in order to increase the likelihood to get a response.

Another embodiment of the narrowing-centralizing approach is used to optimize the effectiveness of a tooth brushing reminder mobile application. The goal of this application is to support users to change their lifestyle by brushing their teeth more regularly and correctly (three times per day, two minutes each time, etc.) To accomplish this goal, this tooth brushing reminder application may send different types of messages to the users via their phones; moreover, the phone may be connected to their smart toothbrushes to receive information about the time and duration of brushing. By using the narrowing-centralizing approach, in the beginning, this application will use the data from all users to find the best time (e.g., sending messages at 3:00 am is very annoying for many people, but 8:00 am is a better time) and the best type of messages to be more effective.

After some time, by collecting data from the patterns of the user using the smart toothbrush, the tooth brushing reminder application will be able to find similarities between users, and by using data of these similar users (e.g., other people who brush their teeth every morning, even without any intervention), and the application may then send more effective messages. And by collecting more and more data from this specific user, the application will be able to personalize its services based on the user behavior and preferences.

More generally the narrowing-centralizing approach may be used in the following applications:
Campaign management systems—a care manager wants to invite patients to multiple different care programs so that multiple invitations may be sent to a patient;
Care management—a care team wants to do a daily survey on the health status of a patient;
Patient engagement—a mobile application wants to reach an individual with relevant information about their health status; and
Application personalization—any application that needs the information from the users to be able to personalize its services, but where it is preferred to minimize the number of questions asked (e.g., sport coaching application or a mobile ehealth application).

The narrowing-centralizing approach described above solves the problem or prior approaches where there was a tradeoff between learning time and final performance. The narrowing-centralizing approach allows for fast learning times and excellent personalized performance over time.

The embodiments described herein may be implemented as software running on a processor with an associated memory and storage. The processor may be any hardware device capable of executing instructions stored in memory or storage or otherwise processing data. As such, the processor may include a microprocessor, field programmable gate array (FPGA), application-specific integrated circuit (ASIC), graphics processing units (GPU), specialized neural network processors, cloud computing systems, or other similar devices.

The memory may include various memories such as, for example L1, L2, or L3 cache or system memory. As such, the memory may include static random-access memory (SRAM), dynamic RAM (DRAM), flash memory, read only memory (ROM), or other similar memory devices.

The storage may include one or more machine-readable storage media such as read-only memory (ROM), random-access memory (RAM), magnetic disk storage media, optical storage media, flash-memory devices, or similar storage media. In various embodiments, the storage may store instructions for execution by the processor or data upon with the processor may operate. This software may implement the various embodiments described above including implementing the pseudo code described above.

Further such embodiments may be implemented on multiprocessor computer systems, distributed computer systems, and cloud computing systems.

For example, the narrowing-centralizing approach may be implemented as software on a server, a specific computer, on a cloud computing, or other computing platform. This software then learns the policy for contacting a specific user and then sends messages to the specific user. The devices used by the specific user may be any type of computing device, for example, desktop computers, laptop computers, tablets, smart phones, interactive home speakers, smart drug dispensers, media streamers, smart-TVs, smart watches and wearable devices, or any device capable of receiving messages and communicating messages to the user.

Any combination of specific software running on a processor to implement the embodiments of the invention, constitute a specific dedicated machine.

As used herein, the term “non-transitory machine-readable storage medium” will be understood to exclude a transitory propagation signal but to include all forms of volatile and non-volatile memory.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of optimizing user outreach for a subject, comprising:
determining the N closest other users to the subject;
learning an outreach policy for the subject using reinforcement learning based upon outreach data of the N closest other users and the subject;
determining an outreach action for the subject based upon the learned outreach policy;
performing the outreach action;
collecting new outreach data; and
determining a new value of N.

2. The method of claim 1, further comprising repeating with the new value of N the steps of:
determining the N closest other users to the subject;
learning an outreach policy for the subject using reinforcement learning based upon outreach data of the N closest other users and the subject;
determining an outreach action for the subject based upon the learned outreach policy;
performing the outreach action;
collecting new outreach data; and
determining a new value of N.

3. The method of claim 2, wherein the new value of N becomes zero.

4. The method of claim 1, wherein the reinforcement learning includes one of Q-learning and least square policy iteration.

5. The method of claim 1, wherein the outreach action includes sending a message to the subject.

6. The method of claim 5, wherein the learned outreach policy determines the time to send the message and the content of the message.

7. The method of claim 1, wherein determining a new value of N is based upon the new outreach data.

8. The method of claim 1, wherein determining a new value of N is based upon a predetermined function that decreases the value of N.

9. The method of claim 1, wherein determining the N closest other users to the subject includes calculating a distance between the subject and other users based a predetermined set of parameters in the outreach data.

10. A non-transitory machine-readable storage medium encoded with instructions for optimizing user outreach for a subject, comprising:
instructions for determining the N closest other users to the subject;
instructions for learning an outreach policy for the subject using reinforcement learning based upon outreach data of the N closest other users and the subject;
instructions for determining an outreach action for the subject based upon the learned outreach policy;
instructions for performing the outreach action;
instructions for collecting new outreach data; and
instructions for determining a new value of N.

11. The non-transitory machine-readable storage medium of claim 10, further comprising repeating with the new value of N the instructions for:
determining the N closest other users to the subject;
learning an outreach policy for the subject using reinforcement learning based upon outreach data of the N closest other users and the subject;
determining an outreach action for the subject based upon the learned outreach policy;
performing the outreach action;
collecting new outreach data; and
determining a new value of N.

12. The non-transitory machine-readable storage medium of claim 11, wherein the new value of N becomes zero.

13. The non-transitory machine-readable storage medium of claim 10, wherein the reinforcement learning includes one of Q-learning and least square policy iteration.

14. The non-transitory machine-readable storage medium of claim 10, wherein the outreach action includes sending a message to the subject.

15. The non-transitory machine-readable storage medium of claim 14, wherein the learned outreach policy determines the time to send the message and the content of the message.

16. The non-transitory machine-readable storage medium of claim 10, wherein instructions for determining a new value of N is based upon the new outreach data.

17. The non-transitory machine-readable storage medium of claim 10, wherein instructions for determining a new value of N is based upon a predetermined function that decreases the value of N.

18. The non-transitory machine-readable storage medium of claim 10, wherein instructions for determining the N closest other users to the subject includes calculating a distance between the subject and other users based a predetermined set of parameters in the outreach data.
